(19) United States
(12) Patent Application Publication
(10) Pub. No.: US 2006/0033636 A1
(43) Pub. Date: Feb. 16, 2006

(54) Controlling an infrared responsive device

(76) Inventors: Wah Yiu Kwong, Beaverton, OR (US); Wayne L. Proefrock, Hillsboro, OR (US); Hue V. Lam, Portland, OR (US)

Correspondence Address: TROP PRUNER & HU, PC, 8554 KATY FREEWAY, SUITE 100, HOUSTON, TX, 77024, US

(21) Appl. No.: 10/915,832

(22) Filed: Aug. 11, 2004

(51) Int. Cl. H04N 5/44

(52) U.S. Cl. 340/825.72; 348/734

(57) ABSTRACT

A technique includes receiving a command packet over a radio frequency communication link and determining whether additional processing of the command packet is needed. Based on the determination, the technique includes selectively communicating an indication of the command packet over an infrared communication link and communicating an indication of the command packet over the radio frequency communication link.

### BACKGROUND

The invention generally relates to controlling a device that is responsive to infrared signals.

A conventional remote control device may use infrared communication to control a particular target device, such as a television set, VCR, DVD player, stereo tuner, etc. A potential challenge in using infrared communication is that this type of communication may require a “line of sight” between the remote control and target devices. In other words, a direct or unobstructed path typically must exist between the infrared light emitting diode (LED) of the remote control device and the infrared photo sensor of the target device. Thus, for example, one may be prevented from storing a particular target device, such as a stereo tuner, DVD player, etc., in an enclosed cabinet for aesthetic purposes due to the line of sight restriction. Furthermore, even when the infrared photo sensor of the target device is generally exposed, the available control angles between the target and remote control devices may be limited by intervening obstructions. Another challenge in using infrared communication is that the distance between the target and control devices may be limited to a relatively short range, as compared to other types of communication, such as wireless radio frequency communication, for example.

Thus, there is a continuing need for better ways to control an infrared responsive device.

### BRIEF DESCRIPTION OF THE DRAWING

FIG. 1 is a block diagram of a system to control an infrared responsive target device according to an embodiment of the invention.

FIG. 2 is a block diagram of the communication module of FIG. 1 according to an embodiment of the invention.

FIG. 3 is a flow diagram depicting a technique used by the communication module to process a command packet according to an embodiment of the invention.

FIG. 4 is an illustration of command packet processing according to an embodiment of the invention.

FIG. 5 is a flow diagram depicting a technique used by the communication module to process a command packet that contains voice data according to an embodiment of the invention.

FIG. 6 is a block diagram of the host computer of FIG. 1 according to an embodiment of the invention.

FIG. 7 is a flow diagram depicting a technique used by the host computer to process a command packet according to an embodiment of the invention.

FIG. 8 is a flow diagram depicting a technique to generate a command sequence according to an embodiment of the invention.

### DETAILED DESCRIPTION

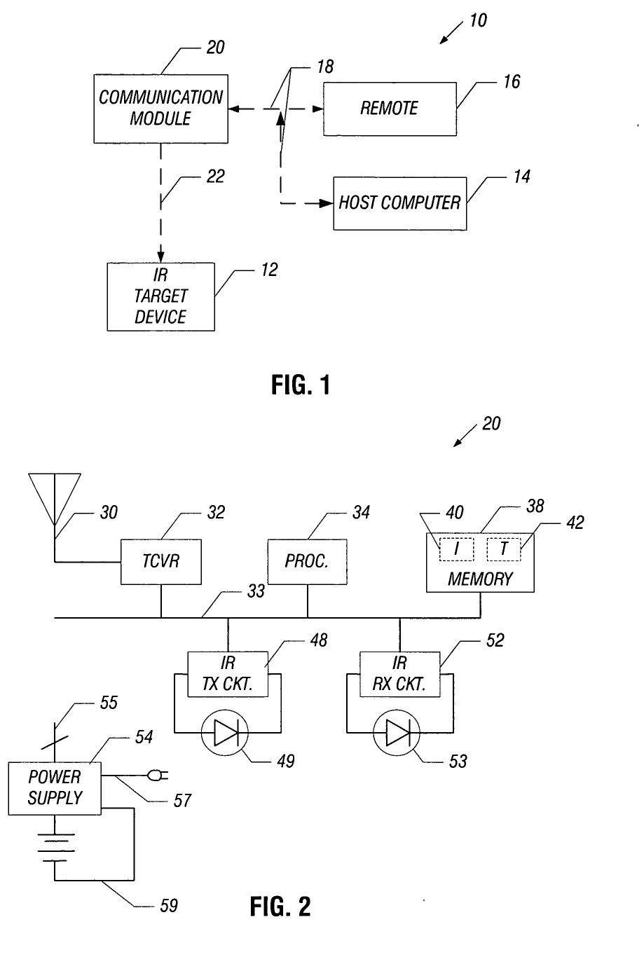

Referring to FIG. 1, an embodiment 10 of a system to control an infrared responsive device (i.e., a device that is capable of at least responding to an infrared frequency signal), such as an infrared target device 12, includes a communication module 20 that establishes a communication bridge between the infrared target device 12 and radio frequency devices (i.e., devices that are capable of communicating wirelessly using radio frequency signals or waves) of the system 10. For purposes of simplifying the discussion of the system 10 herein, FIG. 1 depicts a single infrared target device 12 and multiple radio frequency devices (described below). However, the invention is not to be limited to this exemplary depiction, but rather, in some embodiments of the invention, the communication module 20 may form a communication bridge between multiple infrared devices and one or more radio frequency devices.

As examples, the infrared target device 12, in some embodiments of the invention, may be a disc player (such as a DVD player or CD player), a television tuner, a radio tuner, a stereo tuner, etc., which is controlled by commands that are communicated to the target device 12 by infrared signals or waves that propagate over a wireless infrared communication link 22. The radio frequency devices may include, for example, the remote control device 16 and a host computer 14 that communicate with the communication module 20 over a wireless radio frequency communication link 18. In some embodiments of the invention, the communication module 20, remote control device 16 and host computer system 14 are all capable of communicating with each other over the radio frequency communication link 18; and each of these devices may be capable of bi-directional communication over the link 18, in some embodiments of the invention.

Although the radio frequency communication link 18 is depicted in FIG. 1 as being a relatively straight and unobstructed path, it is understood that communication over the communication link 18 does not require a direct line of sight due to the very nature of wireless radio frequency communication.

The communication module 20 is designed, as described below, to receive radio frequency signals (over the radio frequency communication link 18) into which are encoded commands, some of which may be commands for the infrared target device 12. In some embodiments of the invention, the radio frequency signals communicate command packets, and at least some of these command packets include commands (“tune to a specific channel,” “start recording,” “turn up volume,” etc.) to control the infrared target device 12. As described below, a particular command packet may include a command for the infrared target device 12 as well as include data (a channel assignment, setup data, etc.) for use in controlling the infrared target device 12.

Additionally, as described below, the command packet may indicate that further processing of the command packet by a device other than the communication module 20 (a host computer 14, for example) is needed before the communication module 20 communicates with the target device 12. Thus, the host computer 14 and communication module 20 may work together (as described below) in the processing of one or more command packets for purposes of ultimately generating an infrared data stream to communicate a command to the infrared target device 12. Therefore, the communication module 20 is constructed to establish communication between the remote control device 16, the target device 12 and the host computer 14 (depending on the particular embodiment of the invention) for purposes of controlling the infrared target device 12. As described below, this communication may include unidirectional and bidirectional communication.

Among the possible advantages of the system 10 is that a direct line of sight for controlling the infrared target device 12 is not needed. Additionally, because communication module 20 serves as a communication bridge, devices, such as the remote control device 16 and the host computer 14, are able to use radio frequency communication to control the infrared target device 12. Thus, as compared to infrared-only control, the infrared target 12 may be controlled over longer distances in light of the radio frequency communication.

The communication module 20 may be located in proximity (within one foot, for example) of the infrared target device 12. This is particularly advantageous in that the communication module 20 and the infrared target device 12 may be stored together out of sight (such as in a cabinet or in a particular corner of a room) away from radio frequency devices, such as remote control device 16 or host computer 14, which are the sources of potential commands for the infrared target device 12.

The phrase “radio frequency,” in the context of this application, may include but is not limited to, frequencies that are broadcast over the FM and AM frequency spectrum. More generally, “radio frequency,” in the context of this application, means a frequency between audio frequency and infrared frequency, such as a frequency in the range of about 3 kHz to about 250 GHz, for example.

More specifically, in some embodiments of the invention, the frequency of communication over the radio frequency communication link 18 may primarily fall in the 1-3 GHz range. Additionally, in some embodiments of the invention, the communication link 18 may be a Bluetooth communication link (a link having most spectral energy near 2.4 GHz) that operates pursuant to the Bluetooth Specification, Version 1.2 (November 2003), available from the Bluetooth Special Interest Group (SIG), Inc., at on the worldwide web at bluetooth.org. As another example, in some embodiments of the invention, the radio frequency communication link 18 may be part of a wireless local area network (WLAN), such as the communication in a WiFi™ network that is governed by Institute of Electrical and Electronics Engineers (IEEE) Specification 802.11 (1999). Thus, many variations are possible and are within the scope of the appended claims.

In the context of this application, “infrared is used to refer to light that has a wavelength that is smaller than visible light. For example, in some embodiments of the invention, infrared signals having wavelengths between approximately 870-950 nanometers (nm) may be communicated over the infrared communication link 22. In some embodiments of the invention, the infrared light, pursuant to IrDA, may have a wavelength between approximately 850-900 nm. The infrared signal may be highly directional, which means that infrared devices that communicate with each other must be placed in a direct and unobstructed “line of sight” between these devices. However, in other embodiments of the invention, the infrared communication link 22 may use a diffusion or scatter mode so that a direct line of sight is not required between the communication module 20 and the infrared target device 12.

Thus, as can be seen from the description above, infrared signals that propagate over the infrared communication link 22 have higher frequencies than the radio frequency signals that propagate over the radio frequency communication link 18.

In some embodiments of the invention, the remote control device 12 may be a wireless device, such as a cellular telephone, a personal digital assistant (PDA), notebook computer, etc. that is capable of receiving input (a voice input, keypad input, etc.) from a user converting this input into a command packet; and communicating the command packet over the radio frequency link 18. For communication to control the infrared target device 12, the remote control device embeds an address in the command packet identifying the infrared target device 12, or at least the communication module 20, as the target of the packet. The host computer 14 has similar capabilities for constructing and communicating a command packet to control the infrared target device 12. Furthermore, in some embodiments of the invention, the remote control device 16 may be part of the host computer 14 (a wireless add-in card or USB attachment to the host computer 14, as examples).

In embodiments of the invention in which the radio frequency communication link 18 is a Bluetooth communication link, a relatively low power wireless link may be used to control infrared devices out of sight. Use of the system 10 allows users to combine an old infrared technology-based device with newer technology, such as a newer home computer (for example) that has a Bluetooth transmitter that may be used to control the IR-based device.

In some embodiments of the invention, the communication module 20 may have an architecture that is generally depicted in FIG. 2. The architecture may include a processor 34 (representative of one or more microprocessors, or microcontrollers, as examples) that is coupled through a system bus 33 to a transceiver 32. The transceiver 32, in turn, is coupled to an antenna 30 to receive wireless radio frequency signals from the wireless radio frequency communication link 18 and communicate radio frequency signals over the communication channel 16. The transceiver 32, in some embodiments of the invention, decodes the command that is communicated from the remote 16. However, in other embodiments of the invention, the processor 34 through the execution of software decodes the command from the data that is provided by the transceiver 32.

Instruction code 40 to control the possible extraction (depending on the particular embodiment of the invention) of the command as well as other routines that are described herein may be stored in a memory 38 of the communication module 20. The memory 38 may store other data, such as for example, table data 42 that maps the translation of the command received through the communication channel 18 to a pulse stream of data that is generated via the infrared communication link 22 to communicate the command to the infrared target device 12. As depicted in FIG. 2, in some embodiments of the invention, the processor 34, transceiver 32 and memory 38 generally communicate over a system bus 33 of the communication module 20.

In some embodiments of the invention, the communication module 20 includes an infrared transmission circuit 48 that communicates with the processor 34 for purposes of forming infrared light pulses on a light emitting diode (LED) 49. The processor 34 controls the infrared transmission circuit 48 to cause the circuit 48 to, in response to an infrared stream of data, turn on and off the LED 49 to communicate a command over the infrared communication link 22 to the target device 12 (FIG. 1).

The communication module 20, in some embodiments of the invention, may have features that allow bidirectional communication over the infrared communication link 22 in addition to the bidirectional communication over the radio frequency link 18. As a more specific example, in some embodiments of the invention, the communication module 20 may include an infrared receiver. The infrared receiver includes an infrared receiver circuit 52 that is coupled to the bus 33 and an infrared photo receptor 53 that senses pulses of infrared light that is communicated over the infrared communication link 22. The infrared receiver may be used to train the transmitter module 20 to the infrared command encoding for the target device 12, in some embodiments of the invention.

Depending on the particular embodiment of the invention, the communication module 20 may receive power from one or more batteries 59, may receive power from an AC wall plug 57 or may be coupled to the infrared target device 12 (as part of the infrared target device 12, for example) to receive power from the device 12, depending on the particular embodiment of the invention. FIG. 2 depicts a scenario in which a power supply 54 of the communication module 20 may receive power either from the battery 59 or the AC plug 57. Regardless of the particular source of the power for the communication module 20, the module includes power conditioning circuitry to furnish regulated supply voltages to supply communication lines 55 that are coupled to the power-consuming components of the module 20.

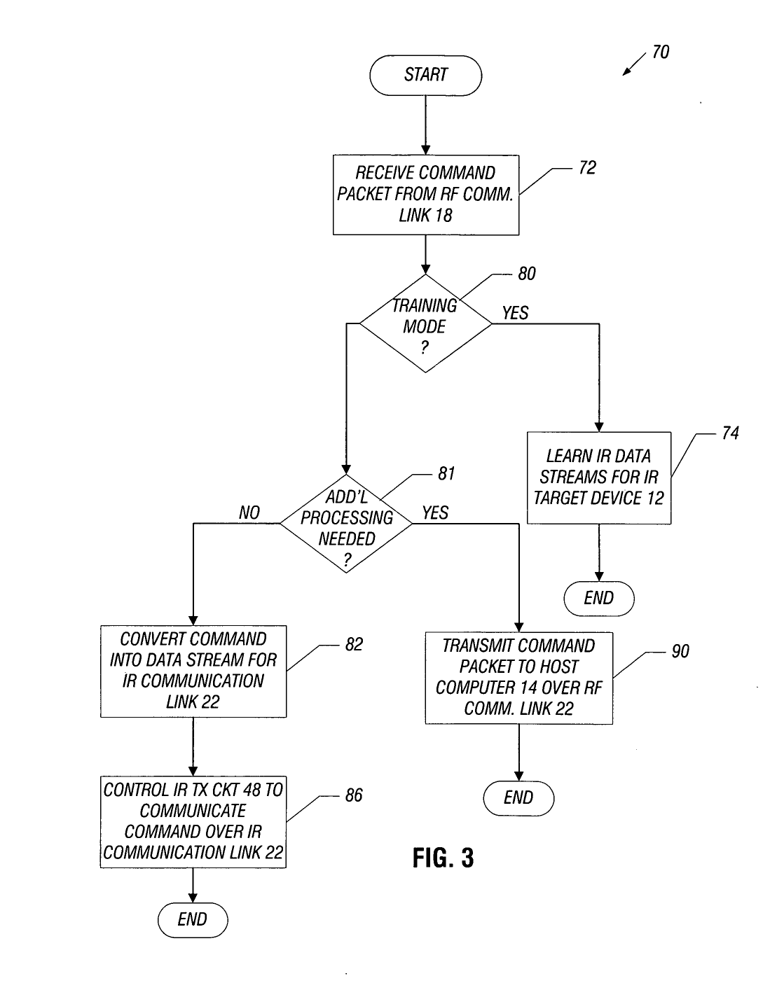

Referring to FIG. 3, in some embodiments of the invention, the instructions 40 (FIG. 2) that are stored in the memory 38 may cause the processor 34, when executed, to perform a technique 70 in response to a command packet being received over the radio frequency communication link 18. Pursuant to the technique 70, the processor 34 retrieves (block 72) the next command packet (communicated over the radio frequency link 18) for processing. Next, the processor 34 determines (diamond 80) whether the communication module 20 is in a learning, or training, mode. In the training mode, the communication module 20 learns (block 74) the particular infrared data stream to be used with the infrared target device 12 for a particular command from the remote control device 16. This training may be performed in various ways, depending on the particular embodiment of the invention.

For example, in some embodiments of the invention, a remote control device (not depicted) that is designed to communicate infrared pulses to the infrared target device 12 may be pointed toward the photo receptor 53 of the communication module 12. During the training mode, a user may be directed to depress certain buttons of the infrared remote control for purposes of learning the infrared pulse data streams for particular commands. In other embodiments of the invention, a user may use the remote control device 16 (or other radio frequency device) to communicate a code to the communication module 20 identifying the type of infrared remote control device that is used by the infrared target device 12. Thus, many variations are possible and are within the scope of the appended claims.

Still referring to FIG. 3, if, during the technique 70, the processor 34 determines (diamond 80) that the communication module 20 is not in a training mode, then the processor 34 determines (diamond 81) whether additional processing of the command packet is needed. For example, as further described below, in some embodiments of the invention, a command packet that is intended for the infrared target device 12 may contain raw voice data. Because the communication module 20 may not be able to process this raw voice data to extract a command for the target device 12 (i.e., the communication module 20 may not have voice recognition capabilities), the communication module 20 may offload the processing of the raw voice data to another device, such as the host computer 14.

Thus, in some embodiments of the invention, if the processor 34 determines (diamond 81) that additional processing of the command packet is needed, then the processor 34 transmits (block 90) an indication of the received command packet to the host computer 14 over the radio frequency communication link 18. Therefore, the bidirectional communication capability of the communication module 20 permits devices other than the communication module 20 to aid in the processing of command packets. Once the host computer 14 further processes the command packet to extract a specific command for the infrared target device 12, then the host computer 14 communicates (via the radio frequency communication link 18) the command back to the transmitter module 20.

When the communication module 20 receives a command packet that does not need further processing, the processor 34, pursuant to the technique 70, converts (block 82) the command into a data stream for communication over the infrared communication channel 22. The processor controls (block 86) the infrared transmission circuit 48 to communicate the command over the infrared communication channel 22.

Alternatively, in some embodiments of the invention, the remote control device 16 may directly offload (via the radio frequency communication link 18) a particular command packet to the host computer 14 for further processing, and after the processing, the host computer 14 communicates the resultant command packet to the communication module 20.

For example, in some embodiments of the invention, a user may dictate a voice command (ultimately for the infrared target device 12) that is digitally captured by the remote control device 16. Because neither the remote control device 16 nor the communication module 20 have voice recognition capability, the remote control device 16 generates a command packet that contains the raw voice data and communicates this command packet to the host computer 14. The host computer 14 uses voice recognition to extract the command for the infrared target device 12 from the raw voice data, generates another command packet that contains this command and then communicates the generated command packet (via the radio frequency communication link 18) to the communication module 20.

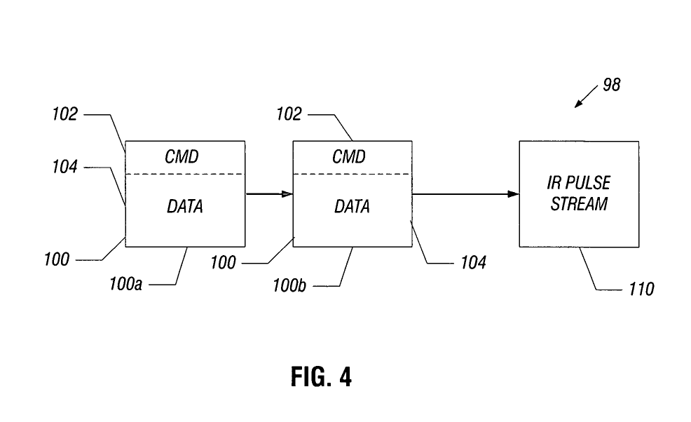

Referring to FIG. 4, thus, in some embodiments of the invention, multiple command packets may be generated in order to communicate a single command to the infrared target device 12. More specifically, in some embodiments of the invention, various command packets 100 (command packets 100a and 100b, depicted as examples) may be communicated over the radio frequency communication link 18 for purposes of ultimately producing an infrared pulse stream 110 to instruct the target device 12 to perform some function. For example, the remote control device 16 may initially communicate a command packet 100a to the communication module 20 over the radio frequency communication link 18. This command packet 100a, in turn, may include data 104 that is associated with the command, such as raw voice data. The raw data may be generated, for example, by a user of the remote control device dictating a command for the target device 12 by speaking into a microphone of the remote control device 16. The remote control device 16 includes an analog-to-digital converter to digitize an analog microphone signal to produce raw voice data that is recorded by the device 16 to form the data 104 of the packet 100a.

On receipt of the command packet 100a, the communication module 20 determines that further processing of the command packet 100a is needed. Therefore, the communication module 20 communicates the command packet 100a over the radio frequency communication link 18 to the host computer 14. The host computer 14 performs voice recognition on the raw voice data to extracts a specific command for the infrared target device 12. The host computer 14 then generates another command packet 100b containing a specific command 102 for the target device 12. The command packet 100b may or may not include additional data 104 for the specific command 102. Upon receipt of the command packet 100b, the communication module 20, assuming no further processing of the command packet 100b is needed by another device, generates an infrared pulse stream 110 to communicate the command to the infrared target device 12 via the infrared communication link 22.

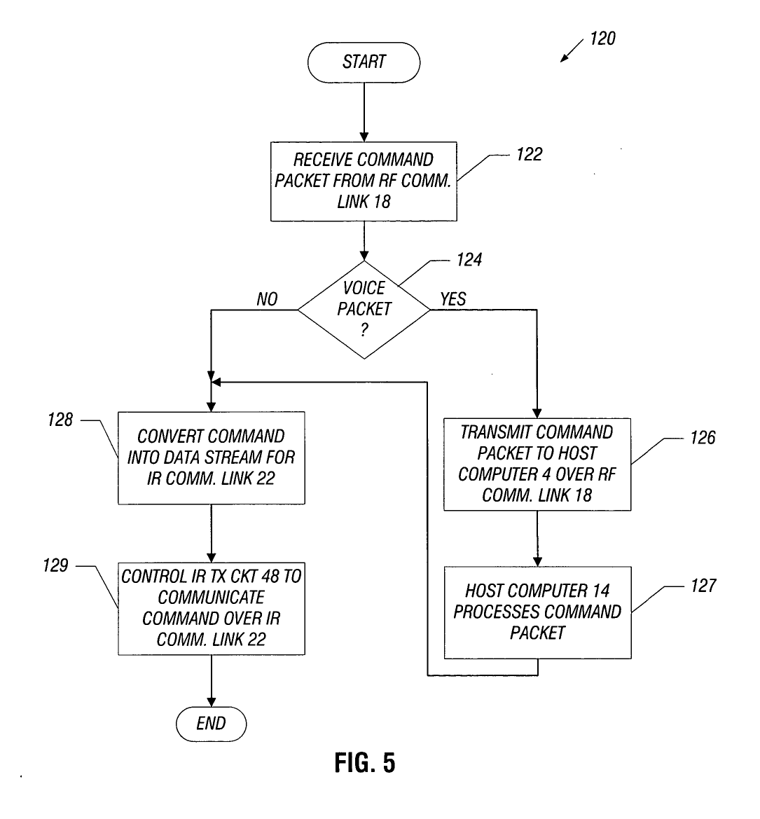

As a more specific example, FIG. 5 depicts a technique 120 that may be used by the communication module 20 to process a voice packet. The processor 34 of the communication module 20, in response to receiving (block 122) a command packet from the radio frequency communication channel 18 determines (diamond 124) whether the packet is a voice packet, i.e., whether the command packet contains raw voice data. If so, then the processor 34 controls the communication module 22 to transmit (block 126) the command packet with the raw voice data to the host computer 14 (via the radio frequency channel 18) for further processing. The host computer 14 then processes the command packet, as depicted in block 127; and control subsequently passes to block 128, similar to the flow that occurs if a determination is made (diamond 124) that the packet is not a voice packet.

The processor 34 converts (block 128) the command contained in the command packet into a data stream for use in generating an infrared pulse stream over the infrared communication channel 22. Next, the processor controls (block 129) the infrared transmit circuit 48 to communicate the command over the infrared communication channel 22 to the infrared target device 12.

In some embodiments of the invention, the host computer 14 may have a general architecture that is depicted in FIG. 6. This architecture may include, for example, a processor 200 (one or more microprocessors or microcontrollers, depending on the particular embodiment of the invention) that is coupled a system bus 202. The host computer 14 may also include a north bridge, or memory hub 204, that is coupled to the system bus 202 for purposes of establishing communication between the processor 200 and a system memory 208. More specifically, the memory hub 204 and the memory 208 may communicate over a memory bus 205.

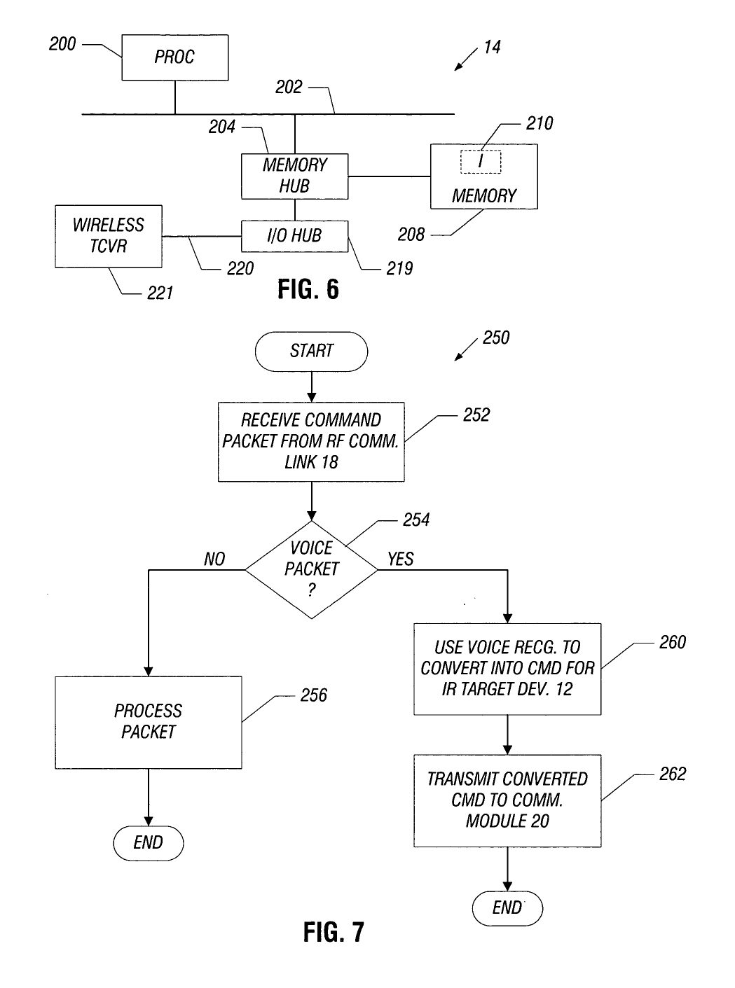

The memory 208 may store various data, such as, for example, instructions 210 to cause the host computer 14 to perform a technique 250 (FIG. 7) that is described below. The memory hub 204 is coupled to a south bridge, or input/output (I/O) hub 219. The I/O hub 219 establishes communication between the components of the host computer 14 and an expansion bus 220. The expansion bus 220 may be coupled to a wireless transceiver 221, a device of the host computer 14, which may be used for purposes of communicating over the radio frequency communication link 18.

In some embodiments of the invention, the host computer 14 may perform a technique 250 that is depicted in FIG. 7. The technique 250 includes the processor receiving (block 252) a packet that was communicated over the radio frequency channel 18. If the processor 200 determines (diamond 254) that the packet is a voice packet to be processed, then the processor uses voice recognition to convert the voice packet into a command for the target device 12, as depicted in block 260. Next, the technique 250 includes the processor transmitting (block 262) the converted command to the module 20. If the processor 200 determines (diamond 254) that the packet is not a voice packet, then in some embodiments of the invention, the processor 200 further processes the packet, as depicted in block 256.

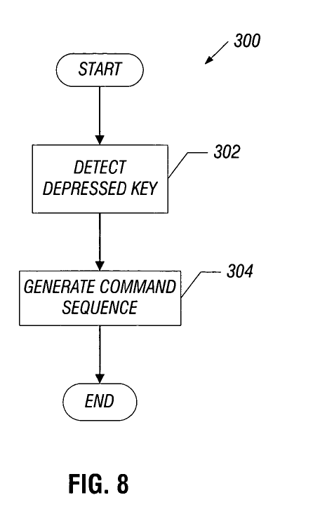

In some embodiments of the invention, a technique 300 that is depicted in FIG. 8 may be used to control the communication of command packets from the remote control device 16 (or any other device, such as the host computer 14). The technique 300 includes detecting a depressed key, as depicted in block 302. The key is associated with a particular function (a function to record a particular television show at a particular time) that is to be performed by the infrared target device 12 or a plurality of infrared target devices 12. This key may be a key in a keypad of a stand-alone remote control device, when the remote control device is separate from the host computer 14; a key on the keyboard of the host computer 14 when the remote control device is part of the host computer 14, etc. Alternatively, other selection devices, such as a “clickable button” on a computer screen (as an example), may be used to select the function.

The selected function is associated with a plurality of commands for the infrared target device 12 or a plurality of infrared target devices 12. For example, the key may select a particular show to be recorded. Thus, the function may include turning on a TV (a first infrared target device 12), turning on a VCR (another target device 12), setting a channel of the TV, instructing the VCR to record, etc., all of which may be associated with separate commands.

Still referring to FIG. 8, in accordance with embodiments of the invention, the technique 300 includes generating a command sequence (block 304) in response to the detected depressed key. The command sequence, thus, includes a list of commands for the various infrared target device(s) 12 to be controlled by the commands. These commands may be communicated by the remote control device 16 via one or more command packets.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method comprising:
receiving a command packet over a radio frequency communication link;
determining whether additional processing of the command packet is needed; and
based on the determination, selectively communicating an indication of the command packet over an infrared communication link and communicating an indication of the command packet over the radio frequency communication link.

2. The method of claim 1, wherein the receiving comprises receiving the command packet by a first entity; and
the communication of the indication of the command packet over the radio frequency link comprises communicating with a second entity separate from the first entity.

3. The method of claim 2, wherein the second entity comprises a computer system.

4. The method of claim 1, wherein the determining comprises determining whether the command packet contains voice data.

5. The method of claim 4, further comprising:
performing voice recognition on the digital voice data to generate another command packet to be communicated across the radio frequency communication link.

6. The method of claim 1, further comprising:
receiving the command packet from a remote control device.

7. The method of claim 1, further comprising:
communicating the command packet to a target device to control the target device.

8. The method of claim 1, wherein the target device comprises at least one of the following: a television, a video disc-based player and an audio player.

9. The method of claim 1, further comprising:
generating the command packet for transmission over the radio frequency link by at least one of a personal digital assistant and a cellular telephone.

10. The method of claim 1, wherein the communicating the indication of the command packet over the infrared communication link comprises:
controlling a pulse data stream of the infrared signal in response to the command.

11. The method of claim 1, wherein the command packet is part of a sequence of commands communicated in response to a function indicated by a user.

12. An article comprising a storage medium readable by a processor-based system and storing instructions to, when executed, cause the processor-based system to:
receive a command packet over a radio frequency communication link,
determine whether additional processing of the command packet is needed, and
based on the determination, selectively communicate an indication of the command packet over an infrared communication link and communicate an indication of the command packet over the radio frequency communication link.

13. The article of claim 12, the storage medium storing instructions to cause the processor-based system to:
communication the indication over the radio frequency link to a second entity separate from the first entity.

14. The article of claim 13, wherein the second entity comprises a computer system.

15. The article of claim 12, the storage medium storing instructions to cause the processor-based system to:
determine whether the command packet contains digital voice data.

16. The article of claim 15, the storage medium storing instructions to cause the processor-based system to:
perform voice recognition on the digital voice data to generate another command packet to be communicated across the radio frequency communication link.

17. The article of claim 12, the storage medium storing instructions to cause the processor-based system to:
receive the command packet from a remote control device.

18. The article of claim 12, the storage medium storing instructions to cause the processor-based system to:
communicate the command packet to a target device to control the target device.

19. The article of claim 12, wherein the target device comprises at least one of the following: a television, a disc-based player and an audio player.

20. The article of claim 12, the storage medium storing instructions to cause the processor-based system to:
control a pulse data stream of the infrared signal in response to the command.

21. A system comprising:
a first wireless interface to receive and transmit over a radio frequency communication link;
a second wireless interface to communicate with a target device over an infrared communication link; and
a processor to control the communication with the target device over the infrared communication link in response to a packet received over the first wireless interface directed to the target device.

22. The system of claim 21, wherein the processor uses the first wireless interface to offload processing of the packet to a computer separate from the system.

23. The system of claim 22, wherein the processor offloads the processing to the computer in response to the packet containing voice data.

24. The system of claim 22, wherein the second wireless interface comprises a bi-directional interface.
